(19) United States
(12) Patent Application Publication
(10) Pub. No.: US 2021/0137252 A1
(43) Pub. Date: May 13, 2021

(54) DUTY BELT WITH COMPARTMENTS FOR MOUNTING REMOVABLE SUPPORT INSERTS

(71) Applicant: Tardigrade Tactical v/Anton Birk Knudsen, Vanløse (DK)

(72) Inventor: Anton Birk Knudsen, Skovlunde (DK)

(21) Appl. No.: 17/095,689

(22) Filed: Nov. 11, 2020

(30) Foreign Application Priority Data
Nov. 12, 2019 (DK) PA 201901327

(51) Int. Cl. A45F 5/02; F41C 33/04; B25H 3/00

(52) U.S. Cl. CPC A45F 5/021; F41C 33/046; A45F 2200/0591; A45F 2200/0575; B25H 3/00

(57) ABSTRACT

Aspects of the present disclosure are directed to a duty belt with a first number of compartments positioned along the length of the duty belt allowing for a second number of removable support inserts to be inserted into the first number of compartments of the user's choice. The duty belt being supportive of loads from objects than can be mounted onto the duty belt having areas in between compartments or portions of an individual compartment not containing removable support inserts Various aspects of the duty belted disclosed herein allow for flexibility in all axis relative to the length of the duty belt making the duty belt supporting to loads and flexible, thereby allowing the duty belt to follow the shape of user's body during movement, and to be folded for storage or transportation.

### CROSS-REFERENCE TO RELATED APPLICATION

This application claims the benefit of priority from Denmark application No. PA 2019 01327, filed 12 Nov. 2019.

### FIELD OF THE INVENTION

This invention relates to a duty belt with compartments for mounting removable support inserts.

### BACKGROUND

Prior art belts have the disadvantages that they are not addressing the users desired and wanted level of comfort. Such belts are rather un flexible or even stiff in one or more directions.

Moreover, known, traditional duty belts have a low level of comfort of the user due to a very rigid overall structure that will not allow for sufficient movement, when or if these are also able to support heavy belt mounted objects sufficiently enough to work as they are intended.

During movement of the user's body, existing known in the art belts will tend to cause discomfort due to the belt being fixed to one or more point(s) or faces around the user's body/waist/belt-line, and will not be able to follow the movement of the users body due the belt being rigid, without flexible areas or sections of the belt, limiting the belts ability to follow the movement of the user's body. If the belt is not fixed to one or more point(s) or faces on the user's body, a traditional/existing belt will tent to dislocate from the intended position due to the effect of a force applied to one point of the belt will travel through the belt, that is fully rigid and not divided into sections, and therefore move the entire belt as an effect of the absence of a flexible area that would otherwise absorb the force applied to the belt.

### SUMMARY OF THE INVENTION

A demand for a duty belt according to the invention is that servers several purpose: it is flexible, comfortable, will not dislocate from the intended position, it allows the user/carrier of the belt to carry even heavy lethal and non-lethal belt mounted weapons or holster for pistols, sub machine guns, rifles, “tasers” or other sidearms or replicas without deforming or stretching the duty belt, if a support-insert is inserted.

The duty belt according to the invention will function for said purposes with or without a removable support insert inserted into a compartment, but by inserting the removable support into a compartment it will increase the functionality by increasing the stability and the load bearing capability of the duty belt.

Each compartment for support inserts may accept several support inserts inserted in one compart or across openings between two or more sections with compartments for removable support inserts. This applies through the present patent application.

Advantages of the present invention:

With the duty belt according to the invention being divided into sections, where a section of the duty belt (1, 2, 3) being defined by a part of the duty belt (1, 2, 3) with or without a compartment (101, 102, 103, 104, 105, 106), with the ability to insert removable support inserts (201, 201x, 202, 203, 204, 205), where needed, a force applied to one section, will be able to be absorbed in the flexible area (601, 602, 603, 604) in between the supported sections of the belt according to the invention or placement of removable support inserts (201, 201x, 202, 203, 204, 205). This will greatly increase the comfort and the intended function of the belt during movement, kneeling, crouching or sitting down or when being worn while sitting in and/or on a human operated or motorized vehicle, aircraft, boat or similar.

When the user of the belt is sitting down, the individual sections of the duty belt (1, 2, 3) with or without compartment(s) (101, 102, 103, 104, 105, 106) for support insert(s) (201, 201x, 202, 203, 204, 205) will enable flexible areas (601, 602, 603, 604) in between sections, so that the duty belt (1, 2, 3) according to the invention will take an alternative shape, due to forces applied to the duty belt (1, 2, 3) and therefore increase the comfort and effectiveness of the user and decrease irritation or pain often experienced when wearing traditional/existing belts for equipment for long periods of time. The user can choose to have one or more removable support insert(s) (201, 201x, 202, 203, 204, 205) only where the user find one or more removable support insert(s) (201, 201x, 202, 203, 204, 205) are necessary, leaving the unsupported sections flexible and comfortable due to more freedom of movement.

This concept of the present inventions duty belt also increases the effectiveness of the user and decreases the likelihood of short- and long-term injuries substantially due to a decreasing of potential point of pressure to nerves around the lower back and pelvis of the user.

Duty belts and belts for the carrying of sidearms such as pistols known from prior art are commonly the width of between 38 and 58 mm, where 38 mm or 1½ inch, 44 mm or 1 23/32 inch or 50 mm or 2 inch, or 58 mm or 2¼ inch, are the most common sizes. Therefore, most holsters or mounts for holsters, for side arms such as pistols are made to be compatible with said sizes of duty belts known form prior art. The benefit of this invention is that the invention will incorporate new features with advantages and still be compatible with holsters or mounts for holsters that are known in the prior art. This in advantage due the fact that the duty belt according to this invention can be implemented into a combination of equipment without having to also change other parts of the combination of the equipment. This will decrease the cost of acquiring a more ergonomic duty belt according the this invention.

From U.S. Pat. No. 5,152,443 is known a duty belt with a number of compartments having areas in between the compartments allowing for flexibility in all axis relative to the length of the duty belt.

The subject matter of claim 1 differs from U.S. Pat. No. 5,152,443 in the characterizing features of claim 1.

The present invention, thus, has the objects of fulfilling the above mentioned purposes and providing the advantages.

These object are achieved in that the invention has been given the features as defined in the claims.

### BRIEF DESCRIPTION OF THE DRAWINGS

A list of figure is as follows:

FIG. 1 shows an embodiment of a duty belt with compartments

FIGS. 2 and 3 show embodiments of a duty belt with mount for holsters

FIG. 4 shows an embodiment of a duty belt with bending of area

FIG. 5 shows an embodiment of a duty belt with areas between compartments

FIG. 6 shows an embodiment of a duty belt with a closure

FIG. 7 shows embodiments of removable support inserts

FIGS. 8 and 9 show embodiments of a duty belt with mount for a holster

FIGS. 10 and 11 show embodiments of a folded duty belt

FIG. 12 show an embodiment of a closed duty belt

FIG. 13 show an embodiment of a duty belt with compartments and a removable support insert

FIG. 14 shows more embodiments of removable support inserts

FIG. 15 show an embodiment of a duty belt with interlocking griping materials of an inner belt

FIG. 16 show an embodiment of a duty belt with a set of openings

FIG. 17 shows embodiments of removable support inserts applied to a force

### DETAILED DESCRIPTION

Embodiments of the invention are described in greater detail in the following.

Described below are specific embodiments of that which the inventor considers at present to be the best mode of fabrication, assembly and operation for carrying out the invention. These are necessarily narrow embodiments and cover only a few of the many possible ways to practice the invention.

Throughout the description and figures the following parts are referenced to:

Duty belt: 001 or 1, 002 or 2, 003 or 3

Compartments: 101, 102, 103, 104, 105, 106,

Removable support inserts: 201, 202, 203, 204, 205 and 201a, 201b, 201b, 201c, 201d, 201e, 201f, 201g also generally denoted 201x.

Twisted removable support insert: 202

Removable support inserts deforming due to an applied force: 203, 204

Mounted holster mounted around the belt: 301

Mounted holster mounted with belt passing through openings: 302,

Mounts for holsters and holsters: 301, 302, 306, 307, 308

Openings in mounts for holsters, displaying meaning of size of these openings: 302A, 302B, 302C, 302D

Mounted MOLLE/PALS compatible 401 pouch 303, 304, 305:

MOLLE/PALS compatible: 401

Buckle closing method 501, 503

Overlapping closing method: 502

Flexible area in between sections: 601, 602, 603, 604

Interlocking or gripping material such as Hook and loop: 701, 702, 703, 704, 705, 706, 707, 902, 903

Folded duty belt: 801, 802

Inner belt: 901

FIGS. 1-17 show examples of embodiments of the invention.

### The Removable Support Inserts 201, 201a, 201b, 201c, 201d, 201e, 201f, 201g, 202, 203, 204, 205

The removable support inserts (201, 201x, 202, 203, 204, 205) are made from solid, perforated, flexible, chained or interlinked bodies that are flexible to take a shape, around the user's body. The removable support inserts (201, 201x, 202, 203, 204, 205) can be constructed from different materials depending on the requirement of the specific version of the duty belt (1, 2, 3) and of the removable support inserts (201, 201x, 202, 203, 204, 205). Materials can be High-density-poly-ethylene (HDPE or PEHD) that is a durable, flexible materials with properties suitable for circumstances where the duty belt (1, 2, 3) is exposed to harsh environmental elements such as moist, heat and cold, and circumstances where the belt is exposed to forces applied from blunt force trauma or impacts of other object onto the duty belt (1, 2, 3) or if the user, wearing the duty belt (1, 2, 3) falls to the ground or hits an object during movement. Said material can be manufactured in different thicknesses to accommodate the need of end user. The user can choose between removable support inserts (201, 201x, 202, 203, 204, 205) with different dimensions and materials for a combination of different types of removable support inserts (201, 201x, 202, 203, 204, 205). Other materials that the support inserts (201, 201x, 202, 203, 204, 205) can be constructed from metals; flexible metals and rigid metals also including shaped removable support inserts (201f) of any type of material. Removable support inserts (201, 201x, 202, 203, 204, 205) can also be made from 3D printed or shape-/injection-molded plastics, nylons and similar materials to a specific shape or with the option of text, symbols or similar into the removable support inserts (201, 201x, 202, 203, 204, 205) itself. The removable support inserts (201, 201x, 202, 203, 204, 205) can also be made from organic materials such as mood and other materials from plants. Removable support inserts (201, 201x, 202, 203, 204, 205) can also be made from composites from a combination of different materials, chemicals and components. Removable support inserts (201, 201x, 202, 203, 204, 205) can also be made from ceramic materials shaped to a desired shape. Removable support inserts (201, 201x, 202, 203, 204, 205) can also be made from durable and blunt force resistant glass-technologies.

Due to the shape of the removable support inserts (201, 201x, 202, 203, 204, 205), when made from a flexible or semi-rigid material (202, 203, 204, 205) and these are twisting (202) or bending (203) when inserted into the compartments (101, 102, 103, 104, 105, 106, 107) of the duty belt (1, 2, 3) and worn around the waist of the user, the removable support inserts become supporting of loads that are applying a force to the duty belt (1, 2, 3) in a lateral (1001) direction relative to the user's body, when wearing the duty belt (1, 2, 3) standing up and transverse to the length of the removable support insert (203) as shown in FIG. 17. The removable support insert (203) will remain flexible in a horizontal direction when applying a force (1003) in a horizontal direction which allows the belt to follow the shape of the user's body. A removable support insert (205, 204) that is flexible will deform to a sub optimal shape when applying a force (1002) in a lateral or transverse direction (1002) relative to the length of the duty belt (1, 2, 3) when not twisted (202) or bend. (203) around the user's body. Exploiting said properties of flexible removable support inserts (201, 201x, 202, 203, 204, 205) a flexible belt that will support loads from object and follow the movement of the user and be easy to stow away for transportation (FIG. 10, FIG. 11) is made possible.

This helps stabilizing the duty belt (1, 2, 3) limiting the deformation of the duty belt (1, 2, 3) when applying a force in a lateral or transverse direction (1001) relative to the length of the duty belt (1, 2, 3) but still be flexible enough (203) to fit around and to follow the movement of the user's body, to increase comfort and to keep the duty belt (1, 2, 3) in place with our without the combination with a compatible inner belt (901) during movement, kneeling, crouching or other bodily movements. The individual sections of the duty belt (1, 2, 3) when supported by removable support inserts (201, 201x 203, 204 205) will twist (202), bend (203) and move (FIG. 6) independently relative to each other due to flexible areas (601, 602, 603, 604) between the sections, compared to belts known from prior art that does not allow for sections of adjustable support from removable support inserts (201, 201x, 202, 203, 204, 205). The construction of the duty belt (1, 2, 3) will increase the range of movement of the user, compared to existing belts with the same intended purpose as the duty belt (1, 2, 3), due to individual sections with compartments (101, 102, 103, 104, 105, 106) for removable support inserts (201, 201x, 202, 203, 204, 205) and also due to a optional combination of sections and compartments (101, 102, 103, 104, 105, 106) with either inserted removable support inserts (201, 201x, 202, 203, 204, 205) or empty compartments (101, 102, 103, 104, 105, 106) without inserted support inserts (201, 201x, 202, 203, 204, 205), or sections of the belt (1, 2, 3) without a compartment for removable support inserts (201, 201x, 202, 203, 204, 205).

Description of what is meant by section and flexible areas (601, 602, 603, 604) in between sections: section is a term used to describe a part of the duty belt (1, 2, 3) with or without a compart (101, 102, 103, 104, 105, 106) for removable support inserts (201, 201x, 202, 203, 204, 205). The area in between sections (601, 602, 603, 604) can be described as a part of the duty belt (1, 2, 3) without a compartment (101, 102, 103, 104, 105, 106) that is in between sections that allows for movement, in all axis, between sections with or without compartments (101, 102, 103, 104, 105, 106) for removable support inserts (201, 201x, 202, 203, 204, 205). A section of the duty belt (1, 2, 3) can be a rigid or semi-rigid section due to a material similar to, or with the same properties as, the removable support inserts (201, 201x, 202, 203, 204, 205), but be permanently installed into the section of the duty belt without the ability to be removed.

For example: a version of the duty belt could be made so that there are a total of 3 sections: two sections meant for each side; left and right side of the user's body, can be sections with compartments (101, 102, 103, 104, 105, 106) for removable support inserts (201, 201x, 202, 203, 204, 205) with a 3rd section on the rear of the user's body, that is connecting the two first mentioned sections, placed on the rear of the user's body that can be a section with or without a compartment (101, 102, 103, 104, 105, 106) for removable support inserts (201, 201x, 202, 203, 204, 205), resulting in the duty belt (1, 2, 3) being flexible between each section to allow for a high level of movement for the user and still being supporting to loads.

The shape of the removable support inserts (201, 201x, 202, 203, 204, 205) can be the shape of a; rectangle (201, 201b); trapezium (201e), parallelogram (201c); elliptical; oval; octagon or any other shape of a combination of straight lines and curves. The removable support inserts (201, 201x, 202, 203, 204, 205) can also be shaped to a fixed shape of a curve (201f) or multiple angled sections on one removable support insert (201). The removable support insert (201, 201x, 202, 203, 204, 205) can be an assembly of several bodies interlinked to form one support insert (201g). The removable support inserts (201, 201x, 202, 203, 204, 205) can be perforated in any shape or type of construction (201d).

The thickness of the removable support inserts (201, 201x, 202, 203, 204, 205) can be of an even thickness or a shape with an uneven or inconsistent thickness of the individual removable support insert (201, 201x, 202, 203, 204, 205).

### Shape of the Duty Belt also Understood as the Duty Belt (1, 2, 3)

The shape of the duty belt (1, 2, 3) can be; a combination of individually curved sections; a combination of curved and straight sections; a combination of collinear and angles sections of straight and/or curved sections. The shape of the individual sections of the duty belt (1, 2, 3) can be of parallel and non-parallel sides in all axis allowing for sections of the duty belt (1, 2, 3) to have a different shape than other sections of the duty belt (1, 2, 3). This will increase the comfort of wearing the duty belt (1, 2, 3) for a long period of time, when one section or portion of the duty belt (1, 2, 3) can be made wider that other sections allowing for better distributing the load of the duty belt (1, 2, 3) to body over a larger surface area, while having other sections or portions of the duty belt (1, 2, 3) being low profile or compatible with holsters or mounts for holsters 301, 302, 306, 307, 308) known from prior art. A curvature in sections of the duty belt (1, 2, 3) or a non-collinear angle between two adjacent sections as shown in FIG. 3, FIG. 4, FIG. 5, and FIG. 13, of parallel sides can increase comfort to and better fit around the waist when the sides of the sections of the duty belt (1, 2, 3) must be parallel or of the same radiuses, due to said shapes will follow the shape of the human hip better that at traditional belt known from prior art, that is straight, with parallel and collinear sides.

Size of the duty belt (1, 2, 3): length of the belt can be constructed to fit different waist sizes, with a build in portion of the belt being adjustable for adjustment of the size at the preference and size of the user.

The width, also understood as the height of the duty belt (1, 2, 3) is of such size that portions of the duty belt (1, 2, 3) or the entire duty belt (1, 2, 3) can slide through opening(s) (302a, 302b, 302c, 302d) on mounts for holsters (301, 302, 306, 307) and holsters with integrated openings (308) making the duty belt (1, 2, 3) compatible with holsters for a sidearm/pistol with a mount (301, 302, 306, 307) with openings or holsters with integrated openings (308) of such size that they will accept existing belts used for the same purpose as the duty belt (1, 2, 3). Duty belts and belts for the carrying of sidearms such as pistols known from prior art are commonly the width of between 38 and 58 mm, where 38 mm or 1½ inch, 44 mm or 1 23/32 inch or 50 mm or 2 inch, or 58 mm or 2¼ inch, are the most common. Therefore, most holsters or mounts for holsters, for side arms such as pistols are made to be compatible with said sizes of duty belts known form prior art.

### Compartments (101, 102, 103, 104, 105, 106) for the Removable Support Inserts (201, 201a, 201b, 201c, 202d, 201e, 201f, 201g, 201e 202, 203, 204, 205)

Compartments (101, 102, 103, 104, 105, 106) for the removable support inserts (201, 201x, 202, 203, 204, 205): the compartment(s) (101, 102, 103, 104, 105, 106), build into the duty belt (1, 2, 3), can allow for the removable support inserts (201, 201x, 202, 203, 204, 205) to move freely in all axis of the duty belt (1, 2, 3); or to keep the removable support inserts (201, 201x, 202, 203, 204, 205) fixed in the compartment(s) (101, 102, 103, 104, 105, 106). The removable support inserts (201, 201x, 202, 203, 204, 205) can be inserted from all sides of the duty belt (1, 2, 3) with or without a lid and/or locking mechanics, to keep the removable support inserts (201, 201x, 202, 203, 204, 205) in place. The removable support inserts (201, 201x, 202, 203, 204, 205) can be inserted into the compartments (102, 103, 104, 105, 106) from all sides of the compartment, being kept in place in the compartment by friction or by restrictions due to the shape of the duty belt (1, 2, 3) when worn by the user or by a fixating mechanism of overlapping pieces of materials or by a closing mechanism such as zippers, hook and loop, magnets, buttons or similar mechanical closing technologies. The compartments (101, 102, 103, 104, 105, 106) can be of such character that one compartment (101, 102, 103, 104, 105, 106) can have openings in more that one side of the compartment (101, 102, 103, 104, 105, 106) therefore also allowing for one or more support inserts (201, 201x, 202, 203, 204, 205) to be inserted into one compartment. For example a version of the duty belt can have one compartment with an opening the compartment (101, 102, 103, 104, 105, 106) on each end of the duty belt, allowing for two removable support inserts (201, 201x, 202, 203, 204, 205) to be inserted into one compartment (101, 102, 103, 104, 105, 106) but being placed at each side of the belt, close to the closing mechanism or on each side, left and right, of the users waist.

### Design Features of the Duty Belt (1, 2, 3)

The features of the duty belt (1, 2, 3) can include slots or channels allowing for vertical mounting-straps or mounting pieces from a mounting assembly/platform for a holster (301) a pouch (303, 304, 305) or similar. The slots can be attached, build-in or cut into the material of the duty belt (1, 2, 3) on the outside or on the inside of the duty belt (1, 2, 3). The duty belt (1, 2, 3) can have MOLLE/PALS (401) compatible mounting features on the inside or on the outside of the duty belt (1, 2, 3) making the duty belt (1, 2, 3) compatible with MOLLE/PALS (401) compatible equipment. The use of MOLLE/PALS equipment in Law Enforcement, military and competitive shooting segments are increasing and many duty belts known from prior art is not made to be compatible with MOLLE/PALS equipment (303, 304, 305, 401), making MOLLE/PALS equipment (303, 304, 305, 401) mounted onto duty belts known from prior art, very unstable due to lack of mounting features. Adding the MOLLE/PALS compatible feature will increase the stability of the mounted MOLLE/PALS equipment (303, 304, 305, 401) and can also make it possible for interlocking or gripping material such as hook and loop (701, 702, 703, 704, 705, 706, 707, 902, 903) that is compatible with an inner belt (901), to be exposed and not covered by the mounting pieces of the MOLLE/PALS equipment (303, 304, 305, 401) as shown in FIG. 3.

As regards the MOLLE/PALS 401 compatible equipment, cited from Wikipedia: MOLLE similar in pronunciation to the name Molly is an acronym for Modular Lightweight Load-carrying Equipment. It is used to define the current generation of load-bearing equipment and backpacks used by a number of NATO armed forces, especially the British Army and the United States Army.

The system's modularity is derived from the use of Pouch Attachment Ladder System, PALS webbing equipment as rows of heavy-duty nylon stitched onto the vest to allow for the attachment of various compatible pouches and accessories. This method of attachment has become a de facto standard for modular tactical gear, replacing the All-purpose Lightweight Individual Carrying Equipment system used in the earliest modular vest systems, which is still in use with many police forces.

The duty belt (1, 2, 3) can have said MOLLE/PALS compatible (401) features while still allowing for belt-mount-compatible equipment being attached in, on and/or over these MOLLE/PALS compatible (401) features.

The features of the duty belt (1, 2, 3) can also include Interlocking or griping material (701, 702, 703, 705, 706, 707, 902, 903) compatible with an inner belt (901) with similar interlocking or gripping material (701, 702, 703, 705, 706, 707, 902, 903) such as hook and loop on the inside of the duty belt (1, 2, 3) making the duty belt (1, 2, 3) compatible with hook and loop compatible inner belts known from the prior art, that help keeping the duty belt (1, 2, 3) in place on the user's waist during movement. This interlocking or gripping material (902, 903) or hook and loop compatible material (701, 702, 703, 705, 706, 707, 902, 903) can be incorporated into the design of the duty belt (1, 2, 3) so that the interlocking or griping material (701, 702, 703, 705, 706, 707, 902, 903) is still functioning when MOLLE/PALS compatible (401) pouches (303, 304, 305) the duty belt (1, 2, 3).

### Transportation of the Duty Belt (1, 2, 3)

The duty belt (1, 2, 3) can due to its individual sections be folded (801, 802) while still having the removable support inserts (201, 201x, 202, 203, 204, 205) inserted and objects attached to the duty belt (1, 2, 3). This solves the problem with existing belts that are rigid throughout their construction, being difficult to discretely transport with or without objects mounted on the duty belt (1, 2, 3) in a container such as a backpack, smaller than the total length of the belt itself. This is especially a problem for competitive shooters when transporting firearms from their home and to the shooting range or police officers from one destination to another if not in uniform or on duty. The inability to transport traditional known in the art rigid duty belts for equipment, discretely, can potentially pose a threat of assault or robbery to the user, if the surroundings are aware that the user is potentially carrying a firearm. Existing belts as known in the art are usually carried on the outside of a cargo system, such as a backpack, duffle bag, wheeled carrying system or similar.

### Materials Used in the Construction of the Duty Belt 1, 2, 3

The duty belt (1, 2, 3) and the compartments (101, 102, 103, 104, 105, 106) can be constructed from but now limited to: woven, knit, molded, laminated, printed, stretching and non-stretching textiles and materials or a combination of said materials. In another embodiment, the duty belt (1, 2, 3) can also be constructed from natural or artificial leathers of different types and from different animals or components and raw materials and compositions.

The duty belt (1, 2, 3) in still another embodiment, can also be constructed and manufactured from materials with a unidirectional structure or a combination of unidirectional construction, also in a combination of woven materials and/or coatings/treatment to the face and/or the back face of the material. The duty belt (1, 2, 3) can be constructed from textiles and laminates made of several layers of fabrics and/or fibers. Nylon and polyester fabrics and narrow fabrics such as webbing are most common in construction of duty belts due to mentioned fibers high durability. The duty belt (1, 2, 3) can also be constructed from fabrics or from fibers and materials such as para-aramids (PPTA) (branded products such as Kevlar© and Twaron©), ultra-high-molecular-weight-polyethylene (UHMWPE) (branded products such as Dyneema©) and similar fibers and fabrics with proper-ties like, but not limited to: high abrasion resistance, high tear resistance, high temperature resistance and fire retardant properties. The duty belt (1, 2, 3) can constructed from woven materials and molded and textured or shaped materials, depending on the version of the duty belt (1, 2, 3). Many duty belts in use, today, have a design and an expression either emulating older design made from leather of other materials used for belts, earlier in history, but manufactured from more modern materials such as vinyl, PVC, rubber etc. These design features can be used to express a specific level of authority or aesthetics.

The benefit of being able to construct the duty belt (1, 2, 3) from different materials is that the impression of the duty belt (1, 2, 3) can match the impression of more traditional known in the art duty belts used by law enforcement departments throughout the world, that usually have a build-in pattern for a more aesthetic look. This ability allows the duty belt (1, 2, 3) to be versatile due to benefits of the ergonomics of the duty belt (1, 2, 3) and possible aesthetic look, in accordance to the specific need of the end-user or the end-user's department.

### Materials Used in the Construction of the Removable Support Inserts (201, 201x, 202, 203, 204, 205)

The removable support inserts (201, 201x, 202, 203, 204, 205) can be made from durable, flexible (202, 203,) or semi-rigid materials with properties suitable for circumstances where the duty belt (1, 2, 3) being exposed to harsh environmental circumstances such as moist, heat and cold temperatures below zero degrees Celsius. The removable supports inserts (201, 201x, 202, 203, 204, 205) can be made from a semi-rigid or rigid material that is laminated, molded, milled or in any other way processed into a specific shape if a specific shape is required for a specific purpose.

### Closure of the Duty Belt (1, 2, 3)

The duty belt (1, 2, 3) can be closed by a press-release (501, 503), slide-release, twist-release, pull-release or similar mechanical buckle (501, 503) with the function of joining the ends of the duty belt (1, 2, 3) locking the duty belt (1, 2, 3) around the user's waist. One or both ends of the duty belt (1, 2, 3) can be adjusted so that the size/length of the duty belt (1, 2, 3) will fit the user. The duty belt (1, 2, 3) can also be closed by overlapping the ends (502) of the duty belt (1, 2, 3) and secured with a closing mechanism such as hook and loop or similar interlocking materials (701, 702, 703, 704, 705, 706, 707, 902, 903); magnets; buckle with an interlocking and sliding mechanism.

While the foregoing embodiments of the duty belt invention are at present considered to be preferred, it is understood that numerous variations e.g. in construction of the compartments and the shape, material(s) and stiffness of the removable support inserts (201, 201x, 202, 203, 204, 205) may be made therein by those skilled in the art and it is intended to cover in the appended claims all such variations and modifications as fall within the true spirit and scope of the duty belt invention.

1. A duty belt comprising:
a first number of compartments including areas in between the first number compartments configured and arranged to allow for flexibility in all axis relative to a length of the duty belt;
a second number of removable support inserts configured and arranged to be
inserted into the first number of compartments,
support loads from objects that can be mounted onto the duty belt;
wherein the areas in between compartments or portions of an individual compartment not containing removable support inserts are configured and arranged
for flexibility in all axis relative to the length of the duty belt,
making the duty belt supporting to loads,
allowing the duty belt to follow the shape of user's body during movement, and
also allowing for the duty belt to be folded for storage or transportation; when inserting the second number of removable support inserts (201, 201a, 201b, 201b, 201c, 201d, 201e, 201f, 201g, 202, 203, 204, 205) into the first number of compartments (101, 102, 103, 104, 105, 106)
wherein the first number of compartments are positioned along the length of the duty belt, the first number of compartments configured and arranged to
allow the second number of removable support inserts to be inserted from one or more side(s) of the first number of compartments,
allow at least one removable support insert to be positioned in one individual compartment of the first number of compartments,
secure the removable support inserts in the first number of compartments via friction or by restrictions due to the shape of the duty belt when closed due to an angle created by the bending of the area in between sections, or by a fixating mechanism of overlapping pieces of materials or by a closing mechanism.

2. The duty belt according to claim 1, wherein the first number of compartments being at least one, and the second number of removable support inserts being zero or more.

3. The duty belt according to claim 1, wherein the first number of compartments being at least one, and the second number of removable support inserts being at least two.

4. The duty belt according to claim 1, wherein the first number of compartments being at least two, and the second number of removable support inserts being zero or more.

5. The duty belt according to claim 1, wherein the first number of compartments being at least three, and the second number of removable support inserts being zero or more.

6. A duty belt according to claim 1, wherein the duty belt is such a size that portions of the duty belt are configured and arranged to slide through opening(s) on mounts for holsters and holsters with integrated openings, the openings being parallel or angled relative to each other.

7. A duty belt (1, 2, 3) according to claim 1, wherein the duty belt is of such size that the portions of the duty belt that are configured and arranged to slide through openings in holsters with at least one integrated opening or mounts, for holsters with at least one opening, these portions of the duty belt having a width of 30 mm to 65 mm.

8. The duty belt of claim 1, wherein the duty belt is configured and arranged to be compatible with an inner belt worn by the user, in a way that the duty belt being attached to the inner belt via an interlocking or griping material, thus facing the inside of the duty belt, keeping the duty belt to the same position on the wearers body when worn and during movement, so that the duty belt will not rotate around the body of the wearer or move up and down relative to the inner belt.

9. The duty belt according to claim 1, where sections of the duty belt are configured and arranged to be shaped for an ergonomic fit around the waist of the user, with sides of the duty belt being non-parallel.

10. The duty belt of claim 8, wherein the interlocking or griping material is a hook and loop attaching on the inside of the duty belt and a hook and loop attaching on the outside of the inner belt.

11. The duty belt of claim 1, wherein the closing mechanism is selected from one or more of the following: zippers, hook and loop, magnets, buttons or similar mechanical closing technologies.

12. The duty belt of claim 1, wherein sections of the duty belt are configured and arranged to be shaped for an ergonomic fit around the waist of the user, with sides of the duty belt being curved.

13. The duty belt of claim 1, wherein sections of the duty belt are configured and arranged to be shaped for an ergonomic fit around the waist of the user, with different sections of the duty belt being non-collinear and/or angled relative to one or more adjacent sections.

14. The duty belt of claim 1, wherein sections of the duty belt are configured and arranged to be shaped for an ergonomic fit around the waist of the user, with different sections of the duty belt being shaped so that 2 or more sections of the duty belt have different shapes.

15. The duty belt of claim 6, wherein the height of said opening(s) measuring up to 65 mm, measured from the top of one opening to the bottom of one opening, or from the top of a set of openings to the bottom of the set of openings.

16. The duty belt of claim 1, wherein the duty belt is such a size that portions of the duty belt are configured and arranged to slide through opening(s) on mounts for holsters and holsters with integrated openings, the opening(s) each being of a different size and parallel or angled relative to each other, at least one of the openings measures up to 65 mm when measured from the alignment of the tops of the set of openings to the bottom of the opening that is of the shortest distance from the alignment of tops of the set of openings, being the opening referred to as opening(s).
